(19) United States
(12) Patent Application Publication
(10) Pub. No.: US 2010/0119076 A1
(43) Pub. Date: May 13, 2010

(54) Hearing Protection Device Ear Seal With Acoustic Barrier

(75) Inventors: Russell Monk, Salem, OR (US); Michael Wurtz, Lake Oswego, OR (US); Allan Schrader, Lake Oswego, OR (US)

Correspondence Address: HANCOCK HUGHEY LLP, P.O. BOX 1208, SISTERS, OR, 97759, US

(73) Assignee: The Timao Group, Inc., Lake Oswego, OR (US)

(21) Appl. No.: 12/269,658

(22) Filed: Nov. 12, 2008

(51) Int. Cl. G10K 11/16

(52) U.S. Cl. 381/71.6

(57) ABSTRACT

A hearing protection device such as a headset or headphone having ear cups is provided with ear seals that incorporate an acoustic barrier for attenuating external noise levels in the interior of the ear cups. The ear seals completely encircle the wearer's ear and use cushioning material into which the acoustic barrier is embedded or otherwise associated. The acoustic barrier comprises a strip or flange of material that is denser than the cushioning material and provides enhanced cross sectional attenuation. The acoustic barrier blocks external noise to reduce the level of noise within the internal cell of the ear cup.

Various embodiments of the invention relate to hearing protection devices, and more specifically to an improved ear seal for use in headsets and the like that incorporates an acoustic barrier that attenuates the level of external noise that reaches the interior of the ear cup.

### BACKGROUND

Hearing protection devices such as headsets, headphones and hearing protectors are useful in a variety of endeavors ranging from aviation to military and industrial uses, to home audio use and others. In the industry, the term “headset” generally refers to device that includes a microphone and speakers in each ear cup. The term “headphone” refers to a device that has speakers only, and is therefore a receive-only communications device. A “hearing protector” is an earmuff-only device that is used only for protection of the user's hearing.

Most hearing protectors have two ear cups that are connected to a headband. Each ear cup includes an ear seal that encircles the user's ear—the ear seal has a ring of cushioning material that fits against the user's head around the ear, and helps attenuate the level of noise that reaches the ear. The ear seal is an important component of a hearing protector, as it provides comfort, and more importantly, contributes to the attenuation of external noise so that the interior of the ear seal is relatively quieter than the exterior.

It is of course desirable to minimize the amount of environmental noise that reaches the interior of the ear cup, and hence the user's ear. There are several approaches to noise attenuation, and these may be generally categorized into active and passive noise reduction strategies. Active noise reduction, or noise cancellation, relies upon reversing of waveform polarity to cancel undesirable noise. This type of noise reduction is very effective at low frequencies and can be selective, for example to cancel airplane engine noise.

Passive noise reduction on the other hand is a form of soundproofing that relies upon physical barriers to block, absorb or dampen the energy of sound waves. Ear seals are one form of passive noise reduction. Generally speaking, from a noise attenuation perspective it is best to have a thin ear seal because the noise attenuation properties are better. However, a thin ear seal is likely to be less comfortable, so there is inherently a tradeoff between the comfort of the device and the level of noise reduction that the designer must balance. For example, a variety of foam products, gels and liquid may be used for cushioning/noise attenuation materials in ear seals. The physical properties of the cushioning material directly affect the level of noise attenuation, and comfort. Thick, soft foam tends to conform well to the wearer's head and is quite comfortable, but soft foam does not attenuate noise very effectively. Dense foam is generally better at cross sectional noise attenuation, but tends to be heavier and conforms to the wearer's head less effectively, and is less comfortable.

There is a need for ear seals for use in hearing protective devices that provide more effective noise attenuation, yet are comfortable and highly conformable.

### SUMMARY

To address this and/or other needs, the present invention devised, among other things, exemplary hearing protection devices, such as headsets, headphones, or protective earmuffs, which include a novel ear seal. In one exemplary embodiment, the ear seal includes a ring-like ear cushion and an acoustic barrier ring arranged coaxially with the circumaural ear cushion. The acoustic barrier ring comprises a physical barrier located within the ear seal that is more acoustically dense than the cushioning material so that the barrier acts as a physical barrier to prevent sound from reaching the interior of the ear seal. In some embodiments, the acoustic barrier ring is at least partially buried in the ear cushion. However, in other embodiments the barrier ring lies outside and adjacent the ear cushion. Moreover, in some embodiments the barrier ring takes the form of a circumferential flange extending axially from a base portion of the ear seal. In operation, the barrier ring generally increases the passive acoustic attenuation of the ear seal, and thus mitigates the conventional tradeoff between comfort and noise attenuation. This ultimately enhances the ability of headsets, headphones, and earmuffs to block undesirable noise.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a perspective view of a headset of a type that incorporates an ear cup having an ear seal with an acoustic barrier according to the present invention. In FIG. 1 the ear seal is shown partially cut away.

FIG. 2 is a cross sectional view of the ear seal and a portion of the ear cup illustrating an acoustic barrier associated with the ear seal.

FIG. 3 is a cross sectional view similar to FIG. 1 but of an alternative embodiment of an ear seal according to the present invention, illustrating an acoustic barrier that is formed as an integral part of the ear seal.

FIG. 4 is an exploded view of an ear seal, illustrating the acoustic barrier of FIG. 2 in isolation from the foam used in the ear seal.

FIGS. 5 through 7 are illustrations of some of the many forms that the acoustic barrier according to the present invention may take.

FIG. 5 is a first alternative embodiment of an acoustic barrier according to the present invention.

FIG. 6 is a second alternative embodiment of an acoustic barrier according to the present invention.

FIG. 7 is a third alternative embodiment of an acoustic barrier according to the present invention.

### DETAILED DESCRIPTION OF THE EXEMPLARY EMBODIMENTS

The following detailed description, which references and incorporates the above-identified figures, describes and illustrates one or more specific embodiments of the invention. These embodiments, offered not to limit but to exemplify and teach, are shown and described in sufficient detail to enable those skilled in the art to implement or practice the invention. Where appropriate to avoid obscuring the invention, the description may omit certain information known to those of skill in the art.

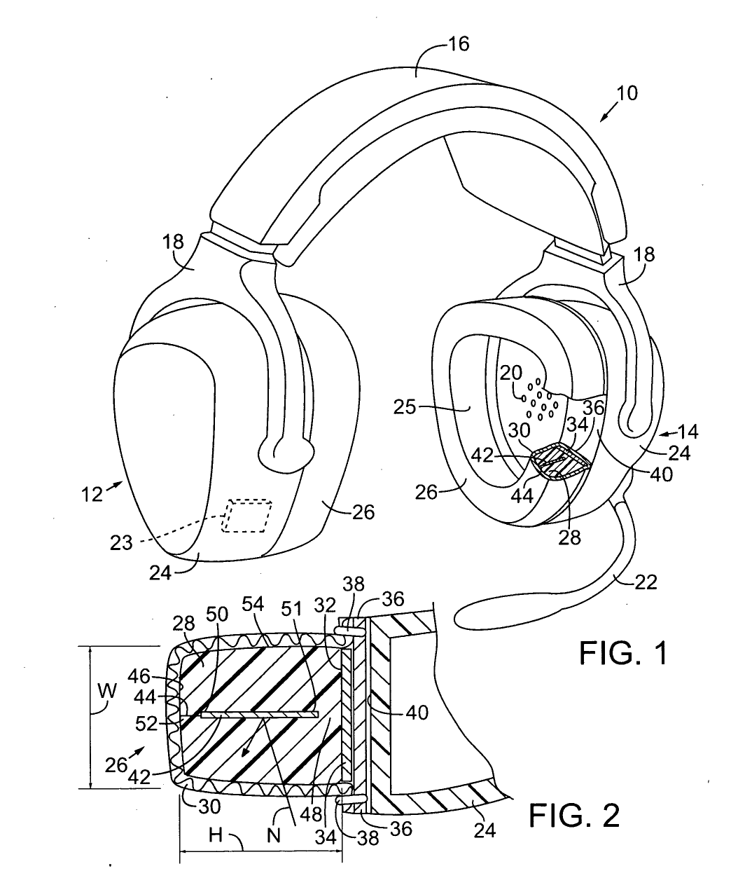

A headset 10 of the type that incorporates an acoustic barrier according to the present invention is illustrated in FIG. 1 as including first and second ear cups 12 and 14 interconnected with a headband 16. The ear cups 12 and 14 are pivotally connected to the headband 16 in a conventional manner, for example with a U-shaped connector 18, so that the ear cups are independently adjustable to better fit the user's head. The headband 16 is designed to exert inwardly directed pressure—“side pressure”—on each ear cup when the headset is being worn. This pushes the ear cups against the user's head, creating a seal around each ear. Each ear cup includes a headphone speaker, shown schematically at 22, and a microphone 20. External communications connections are not shown in the figures. The headset 10 illustrated in FIG. 1 is exemplary only and is intended only to show the general type of hearing protection device into which the acoustic barrier of the present invention may be used. It will be appreciated that the acoustic barrier described and claimed herein may be incorporated into any hearing protection device of any design, including headsets as described herein, headphones, and hearing protectors of the muff type. For example, the acoustic barrier may be incorporated into an active noise reduction (ANR) headphone or headset, such as that shown in U.S. Pat. Nos. 6,704,428; 6,735,316 and 7,215,766, which are incorporated herein by this reference.

Each ear cup 12 and 14 includes a housing 24 to which U-shaped connector 18 is attached. Housing 24 is typically a plastic or metal material and houses the headphone speaker 22, other electronics and components that may be used in the device, and serves as a base for the ear seals 26. For example, the headset 10 illustrated in FIG. 1 is shown schematically as including ANR circuitry, exemplified by circuit board 23. It will be appreciated that the acoustic barrier described herein may be beneficially incorporated in a headset that utilizes ANR circuitry and components, or a headset that does not use ANR technology. It will further be appreciated that the ANR circuit board 23 shown in FIG. 1 is shown in an highly schematic manner to illustrate only that the invention described herein may be used with ANR equipped headsets.

Each ear seal 26 comprises a generally circular ring of cushioning material 28 that attaches directly to the housing 24 such that the ear seal encloses the headphone speaker 22. The cushioning material 28 conforms to irregularities in the user's head. When the headset 10 is worn, the wearer's ears are completely encircled by the ear seals 26 with the ear seals conforming to the wearer's head around the pinna under the side pressure applied by headband 16. The side pressure provides 100% contact between the ear seal and the user's head, even when the wearer is speaking. The ear seals 26 thus provide an effective and isolated chamber or interior cell 25 where the ears rest when the headset is worn. The environment external of the ear seals is referred to herein as the exterior cell.

As indicated above, the design of the ear seals and the cushioning materials used to fabricate the ear seals has a direct and important, and often limiting effect on the level of noise attenuation, and the comfort of the headset. Design of hearing protectors to maximize passive noise reduction involves consideration and balancing of a variety of factors, including the weight of the device, and the amount of side pressure applied by the device on the wearer's head. Each of these factors directly impacts noise attenuation: the best possible goal would be a very light device that requires minimal side pressure and is very comfortable for long periods of time, yet provides a high level of attenuation. As noted, good passive noise reduction requires contact between the ear seal and the wearer's head 360° around the ear. This is referred to as 100% contact. Since no two user's heads are shaped identically, and because the contour of the user's head changes as the user speaks, it is important that the ear seals are designed with the ability to provide 100% contact at all times on all users.

Many different cushioning materials may be used in the ear seals. These include for example open and closed cell foam, silicone gel, liquid, and liquid foam. Choice of one of these over another depends upon other factors. For example, of the materials just listed, silicone gel has the best cross sectional attenuation properties (i.e., the best ability to block external noise) but has the least ability to conform to the wearer's head and thereby create the desired condition of 100% contact and conformance between the user's head and the ear seal. Table 1 provides a list of some basic properties of some common materials used in ear seals.

TABLE 1
Ear Seal Material Characteristics

| | | | Side | Ear |
|---|---|---|---|---|
| Ear Seal | Attenuation | Ability to | Pressure | Seal |
| Material | Properties | Conform | Needed | Weight |
| Silicone Gel | Best | Worst | High | 1.2 oz |
| Liquid | Very Good | Best | Medium | .6 oz |
| Foam/Liquid | Good | Good | Medium | .6 oz |
| Temp-Sensitive | Good | Very Good | Low | .5 oz |
| foam | | | | |

From the foregoing it will be appreciated that selection of one particular material over another requires balancing of the goal of comfort with the best noise attenuation. Liquid demonstrates the best conformance to uneven surfaces such as found on a typical head, but requires relatively higher side pressure because of the vertical orientation of the ear seal; the liquid flows to the lowermost portion of the seal unless the side pressure is sufficient to squeeze the fluid up around the ear. On the other hand, silicone gel tends to provide better attenuation since it stays in place in the ear seal. Foam/liquid and thermal-conforming foams do not have as much cross-sectional density as either liquid or silicone gel to provide the same levels of passive attenuation.

From a comfort standpoint, silicone gel ear seals may not be the best choice because, as noted above, the gel is a dense material and does not easily conform to the many variations posteriorly of human ears. Moreover, silicone gel only conforms under relatively high pressure, compared to the other materials listed. And silicone gel is quite heavy at twice the weight of the other ear seals. Liquid seals require medium side pressure for a good seal, and temperature-sensitive foam materials are excellent for conformability, minimum side pressure, and ear cavity volume. Furthermore, temperature sensitive foam is particularly effective when the user is wearing glasses. The conformability of the foam helps minimize the localized pressure of the arms of the glasses pushing on the wearer's temples.

It will be readily appreciated that the different criteria noted above must all be considered when designing a headset. The present invention as embodied herein and as defined by the claims may be used with any material used for ear seals, including those materials specifically listed above, and enhances the noise attenuation of the ear seal regardless of what type of cushioning is used. Nonetheless, for purposes of the present description of the invention, the ear seal it is illustrated herein and shown in the drawings being used with temperature sensitive foam. This is done by way of example only, and not by way of limitation.

Turning now to FIG. 2, ear seals 26 have in the illustrated embodiment an internal foam core 28 and an external cover 30. The external cover 30 is typically is a soft material such as synthetic leather, vinyl, cloth, leather or similar material that tends to be comfortable, since it rests on the wearer's head. The external cover material contributes little to noise attenuation properties of the ear seal.

As noted above, many different cushioning materials may be used in place of the foam used in foam core 28. Accordingly, the ear seal is at times referred to herein as a circumaural ear ring. This term contemplates an ear seal that uses any cushioning material. The internal foam core 28 described in the present embodiment is preferably soft, conformable foam that provides good noise attenuation qualities. Thermally conforming foam sold under the brand name CONFOR, available through E-A-R Specialty Composites (www.earsc.com), a division of Aearo Company (www.aearo.com) is one example of foam that works well for internal foam core 28. CONFOR is slow recovery urethane foam that softens when exposed to warm temperature, and therefore tends to conform very well to a wearer's head around the ear to provide pressure-free conformance and comfort. CONFOR also provides good noise attenuation performance. The foam core 28 used in accordance with the present invention has a height and width dimension, illustrated on FIG. 2 with the dimensions H and W, respectively.

The flattened base 32 of the internal foam core is bonded to a backing layer 34, which typically is a flexible material such as cloth, but may also be materials such as KEVLAR, plastic and the like. Backing layer 34 is in turn bonded to a backing plate 36, which preferably is a semi-rigid plastic material. The backing plate is a sometimes referred to as the ear shell. As illustrated in FIG. 2, in the assembled ear seal 26 the external cover 30 completely covers the internal foam core 28 and is attached to backing plate 36. The cover 30 may be attached to backing plate 36 in any convenient manner, and in FIG. 2 is shown attached to the backing plate with stitches 38. Cover 30 may also be bonded to the backing plate. It will be understood that there are many alternative and equivalent manners in which to assemble an ear seal of the type described herein.

For reference purposes herein, flattened base 32 defines a first plane that is parallel to the plane defined by shelf 40, described below. Likewise, the surface of the ear seals 26 that contact the user's head, i.e., the outer surface of cover 30, is generally flattened and defines a second plane. The first and second planes are generally parallel, and the first plane is sometimes referred to as the back plane, and the second plane as the front plane.

The ear seal 26 is an independent unit that is detachable from ear cup 14. With reference once again to FIG. 1, ear seal 26 is attached to a circumferential shelf 40 formed on housing 24 that extends around the housing. The backing plate 36 and ear seal 26 have the same circumferential shape as the shelf 40, so the ear seal mates with the ear cup. The ear seal is typically connected to the ear cup with snap-in clips (not shown) such that the ear seal is firmly and securely attached to the housing yet may be easily removed.

Acoustic barrier 42 comprises a relatively thin strip of material that is relatively denser than the foam cushioning material used in the ear seal, in this case foam core 28. Because the acoustic barrier 42 is denser than the cushioning material, it provides significantly increased cross sectional noise attenuation compared to the foam. Acoustic barrier 42 is associated with the foam core 28 such that the strip extends in a direction that is generally transverse to the plane of the shelf 40—i.e., the first plane—onto which ear seal 26 fits when headset 10 is assembled, and also the plane defined by backing material 34 and backing plate 36. Stated another way, there is a central axis extending through the middle of each ear cup 12 that is transverse to the first and second planes; the wall of the acoustic barrier 42 extends parallel to the central axis. As shown in FIG. 1, the orientation of the acoustic barrier within the ear seal results in the strip providing a physical acoustic barrier that blocks external noise from reaching the interior cell 25; the strip attenuates noise having its origins in the exterior cell by physically blocking the sound waves from entering the interior cell 25, and by reflecting the sound waves back to the exterior cell as illustrated schematically in FIG. 2 with arrow N. Since the acoustic barrier 42 provides effective noise attenuation, each of the ear cups 12 and 14 defines an interior cell 25 that is more effectively acoustically isolated from the exterior cell. While the term “blocking” is used to refer to the attenuation of noise entering the interior cell, it will be appreciated that this is a relative term and that not all noise is excluded from entering the interior cell.

A variety of materials may be used to fabricate acoustic barrier 42, but in all cases the material is denser than the cushioning material used in the ear seal such as foam core 28. Preferred materials for acoustic barrier 42 include copper, KEVLAR, rubber, plastics of various types, foams having relatively high density than the cushioning material used for foam core 28, and fiberboard-based materials. It will be appreciated that other materials work well, too. Testing has shown that of the specific materials listed above, copper provides the best noise attenuation properties. However, virtually any material that is more dense than the cushioning material will suffice for acoustic barrier 42. It is also envisioned that acoustic barrier 42 could be formed with a liquid polymer material injected into the foam core, wherein the polymer hardens to form the barrier. Because the acoustic barrier is very thin and light, it does not appreciably increase the weight of headset 10 and has no effect on the conformability of the ear seal to the user's head.

In some cases the material selected for acoustic barrier 42 will be dependent upon the type of foam used for foam core 28. For example, if a relatively dense and non-compressible foam is used for foam core 28, the material selected for acoustic barrier 42 may be relatively stiffer. On the other hand, if foam core 28 is formed of soft foam, a relatively more flexible material may be appropriate for the acoustic barrier.

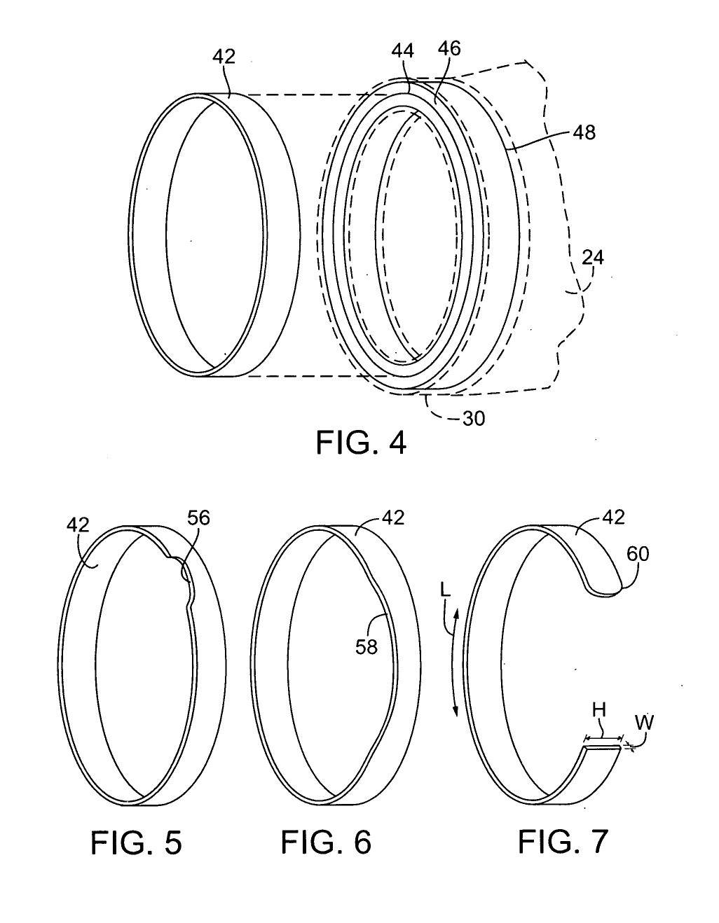

As shown in FIGS. 4 through 7, acoustic barrier 42 may take on several different forms, as detailed below. The barrier may be a continuous endless ring of material as shown in FIGS. 4, 5 and 6, or may be an elongate strip having opposite ends as shown in FIG. 7. Of course, if an elongate strip is used the opposite ends of the strip may overlap one another when the acoustic barrier is assemble with/embedded into the foam core. Regardless of the form used for acoustic barrier 42, the strip has a length dimension, a height dimension and a width dimension (reference letters L, H and W, respectively, in FIG. 7).

Acoustic barrier 42 is inserted into the foam core 28 during manufacture of the ear seal. With reference to FIGS. 2, 3 and 4, a circumferential slit 44 is formed in the material used for foam core 28—the slit 44 is preferably formed in the foam core after the core has been bonded to backing material 34, but the foam core 28 could be slit beforehand, or the foam core could be provided in two annular pieces if desired. In FIGS. 1 and 2, slit 44 extends from the outermost or external portion 46 of foam core 28 toward the backing material 34. The slit 44 may extend completely to the backing material 34, but typically terminates a short distance before the backing material. The strip of acoustic barrier material is then inserted into slit 44, preferably such that the outermost edge 50 of the acoustic barrier is embedded within foam core 28, and spaced apart from the external portion 46 by a short distance. The height of the acoustic barrier 42 may be varied according to need. Generally speaking, the height of the acoustic barrier should be as close as possible to the height of the foam core 28 in order to achieve the best noise attenuation. As noted above, balanced against this need, of course, is the need to provide a comfortable fit for the ear cup. In FIG. 2 the innermost edge 51 of acoustic barrier 42 is spaced a short distance from backing material 34. If slit 44 extends completely to the backing material, the acoustic barrier may abut the backing material.

Once the acoustic barrier 42 is inserted into the slit 44, the cover 30 may be applied to the foam core 28 and the ear seal 26 may be fully assembled with the other components described above. Because the outermost edge 50 of the acoustic barrier 42 resides in foam core 28, there is a portion of foam shown generally at 52 that completely covers the barrier material. This helps insure the comfort of the headset.

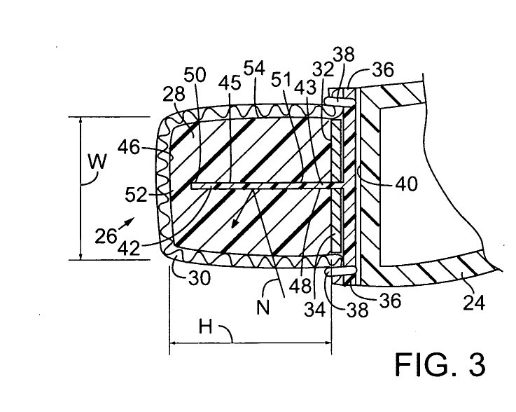

A first illustrated alternative embodiment for the structure of acoustic barrier 42 is shown in FIG. 3. In this embodiment the acoustic barrier 42 is formed as a circumferential flange 43 extending from and around backing plate 36—the flange is thus an extension of the ear shell, or backing plate 36, that extends into the foam core 28. A circumferential slit 45 is cut into foam core 28 and backing material 34, and the flange 43 is inserted into the slit during assembly of the ear seal. The flange 43 is an integral part of backing plate 36. This may be contrasted with the acoustic barrier 42 illustrated in FIGS. 1 and 2, which is essentially “floating” in the foam core 28 because it is surrounded by the foam core and is not physically attached to the backing plate.

An alternative to the embodiment shown in FIG. 3 may be fabricated by forming the flange 43 as a part of the backing material 34 instead of forming the flange 43 as a part of backing plate 36.

In FIGS. 1, 2 and 3, the slit in which the acoustic barrier resides and the acoustic barriers are shown in roughly the axial center of foam core 28. That is, the acoustic barrier is embedded in the foam in a central location. In practice, this orientation will provide the most comfort since those portions of the denser acoustic barrier that could press against the wearer's head are surrounded by foam—the foam thus provides a cushion between the acoustic barrier and the wearer. It will nonetheless be appreciated that the acoustic barrier may be oriented in any position in the ear seal, even for example on the surface 54 of foam core 28 between the foam core and cover 30, or the surface on the opposite side of the foam core. Alternately, the strip could be associated with the cover material, between the cover material and the foam core. Where the cushioning material is a gel or liquid, one edge of the acoustic barrier will typically be fixed to the backing material to prevent the strip from being dislodged. It will be appreciated therefore that the word “associated” is used herein to refer not only to the orientation shown in FIGS. 2 and 3, but to any orientation in which an acoustic barrier strip is used with a foam core or other cushioning material to attenuate noise having its origin in the external cell from entering the internal cell 25.

An ear seal 26 incorporating an acoustic barrier 42 as described herein and as illustrated in the drawing figures defines an ear seal having a cushioning material with a first density in an outer region—that is, externally of the acoustic barrier, a cushioning material having a second density in an inner region—internally of the acoustic barrier, and a third region having a density higher than the first and second regions, i.e., the acoustic barrier. In most instances the acoustic density of the cushioning material in the inner and outer regions is the same, while the density of the barrier is relatively greater.

The relative size dimensions of the headset components may vary widely, depending upon the type of cushioning material used in the ear seal, the material used to fabricate the acoustic barrier, etc. Assuming that the ear seal uses a form core 28 for the cushioning material, a preferred height dimension for the acoustic barrier 42 (dimension H in FIG. 7) is typically about ¼ inch, and the corresponding height of the foam core 28 (dimension H in FIG. 2) is typically about ⅝ inch. As noted above, an acoustic barrier that has a relatively great height in relation to the height of the foam core provides the best noise attenuation. However, comfort concerns must be balanced against this. Accordingly, a preferred embodiment of an ear seal according to the present invention has an acoustic barrier that has a height that is between about 25 to about 85% of the height of the foam core. More preferably, the height of the acoustic barrier may be between about 30 to about 55% of the height of the foam core. It will be appreciated that these dimensions are provided as examples only, and the actual dimensions of the acoustic barrier and foam core will vary depending upon the specific construction for headset 10. The width dimension of the acoustic barrier will vary depending upon factors such as the material selected for the barrier, and the type of cushioning material used. For example, where the acoustic barrier 42 is formed of copper and CON FOR foam is used for foam core 28, it has been found that the preferred height of the barrier is about 40% of the height of the foam core, as good noise attenuation and comfort are achieved with these relative dimensions.

An ear seal fitted with an acoustic barrier as described herein provides significant and substantial noise attenuation. One direct result is that by incorporating an acoustic barrier in the ear seal, a relatively thinner ear seal (i.e., lower height) may be used, and the side pressure may be reduced. Thus, by using an acoustic strip as described herein, the same levels of noise attenuation may be attained with thinner ear seals and less side pressure than conventional devices that require thick ear seals and significantly more side pressure. As a result, the same or better levels of noise attenuation are achieved with better comfort.

As noted above, acoustic barrier 42 may be used in the form of an endless strip (e.g., FIGS. 4, 5, 6), or a strip that has opposite ends (e.g., FIG. 7). Testing has shown that the best noise attenuation is achieved with an acoustic barrier that is in the form of an endless strip that is embedded in the ear seal and extends completely around the ear seal. The actual shape of acoustic barrier 42 may also be varied widely. The ear seal 26 illustrated in FIG. 1 is not circular. As a result, acoustic barrier 42 will of course not be circular; since the acoustic barrier 42 is flexible, the shape of the ear seal may be modified. The acoustic barrier may further be modified in its height dimension along the length of the strip. To provide a few examples, the acoustic barrier 42 shown in FIG. 5 includes a cut out or sculpted portion 56 that is positioned to accommodate the arm of a pair of eyeglasses. Of course, if the user specified a headset 10 for use with eyeglasses, the acoustic barrier 42 in each ear seal 26 would be of the type shown in FIG. 5. The acoustic barrier 42 shown in FIG. 6 has a sculpted portion 58 that could be used to increase comfort by increasing the ability of the ear seal to conform to some head shapes. That is, the sculpted portion 58 could be situated in the ear seal 26 such that it rests on the users head anteriorly of the pinna. In addition, the acoustic barrier may be custom designed to accommodate users having specific fitting needs. Lastly, the acoustic barrier 42 illustrated in FIG. 7 shows one end of the strip having a tapered end 60.

It will be appreciated that when a headset incorporating an acoustic barrier of the type illustrated herein is worn on the head of a user, the strip resides in foam core 28 such that the height dimension of the strip (dimension H, FIG. 7) is generally transverse to the plane defined by the side of the wearer's head. As a result, the strip provides an effective physical barrier that attenuates the level of noise reaching the interior cell 25.

It will be understood that the fixed flange 43 illustrated in FIG. 3 may be combined with a floating barrier 42 in the same ear seal, and that an ear seal may incorporate more than one acoustic barrier, or more than one fixed flange 43. As another alternative, an ear seal could be built with a flange extending partially around the circumference of the device, with a floating barrier extending around the remainder of the ear seal. Other combinations may also be built.

While the present invention has been described in terms of a preferred embodiment, it will be appreciated by one of ordinary skill that the spirit and scope of the invention is not limited to those embodiments, but extend to the various modifications and equivalents as defined in the appended claims.

1. An ear seal for a hearing protection device, comprising:
a cushioned circumaural ear ring; and
an acoustic barrier associated with the ear ring.

2. The ear seal according to claim 1 wherein said acoustic barrier is defined by a material that has a greater density than the density of the cushioned ear ring.

3. The ear seal according to claim 2 wherein the ear ring has a base portion attached to a backing material that defines a first plane, and the acoustic barrier is defined by a strip that extends in a direction generally transverse to the first plane.

4. The ear seal according to claim 3 wherein the acoustic barrier is embedded in the ear ring and extends completely around the ear ring.

5. The ear seal according to claim 3 wherein the ear ring has an outer portion and the acoustic barrier defines an outer edge that is spaced apart from the outer portion of the ear ring.

6. The ear seal according to claim 1 in which the ear ring has a height and the acoustic barrier has a height that is between about 25 and 85% of the height of the ear ring.

7. The ear seal according to claim 6 in which the height of the acoustic barrier is between about 30 to 55% of the height of the ear ring.

8. The ear seal according to claim 5 in which the acoustic barrier defines a strip of material having side edges that are substantially parallel along their entire length.

9. The ear seal according to claim 5 in which the acoustic barrier defines a strip of material having side edges and said strip of material includes a sculpted portion in at least one side edge.

10. The ear seal according to claim 1 wherein the ear ring is attached to a backing material, the backing material is attached to a backing plate, and the ear ring is covered with a cover material.

11. The ear seal according to 3 wherein the acoustic barrier is copper.

12. The ear seal according to claim 1 wherein the ear seal includes a base member and the acoustic barrier is an integral part of the base member.

13. The ear seal according to claim 12 wherein the acoustic barrier is a flange extending around the base member and into the cushioned ear ring.

14. In a hearing protector having an ear cup, the improvement comprising:
an ear seal defining a ring configured for encircling an ear to thereby define an interior cell and an exterior cell when the ear cup is worn on a human head, the ear seal having a height dimension and a width dimension; and
acoustic barrier means associated with the ear seal for providing a physical barrier that attenuates sound originating in the exterior cell and reducing the level of sound reaching the interior cell from the exterior cell.

15. The improvement according to claim 14 wherein the acoustic barrier means further comprises a strip of material embedded in the ear seal and having a density that is greater than the density of the material used to form the ear seal.

16. The improvement according to claim 15 wherein the strip of material extends completely around the ring.

17. The improvement according to claim 15 wherein the ear seal has a base plate that defines a first plane and the strip has a height dimension that extends generally transverse to the first plane.

18. The improvement according to claim 16 wherein the strip is copper.

19. A method of attenuating noise in a hearing protector having an ear cup, comprising the steps of:
a) providing an ear seal defined by a cushioned circumaural ring; and
b) orienting in the ring an acoustic barrier strip.

20. The method according to claim 19 including the step of orienting the acoustic barrier strip in the ring such that the barrier strip has a height dimension that extends in a direction generally transverse to the plane defined by the side of a user's head when the headset is being worn.

21. The method according to claim 20 including the step of embedding the acoustic barrier strip in the ring so that the material used to form the ring completely surrounds the strip.

22. The method according to claim 21 including the step of forming the acoustic barrier strip with a sculpted portion to accommodate eye glasses.

23. A method of attenuating noise in a hearing protector having an ear cup, comprising the steps of:
a) providing an ear seal having a cushioned circumaural ring having a first density at a first region and a second density at a second region, wherein the second density is greater than the first density and wherein the ear seal defines when worn on a human head an interior cell within the ear seal and an exterior cell external to the ear seal;
b) reflecting sound originating in the exterior cell off the barrier material to lessen the level of sound entering the interior cell.

24. A method of attenuating noise in a hearing protector having a cushioned ear cup, comprising the step of reflecting sound off a surface within the cushioned ear cup wherein the surface has a higher density than the cushioning material.

25. An ear seal for a hearing protection device, comprising:
a cushioned circumaural ear ring that defines an interior cell and an exterior cell; and
barrier means associated with the cushioned ear ring for blocking sound originating in the exterior cell from entering the interior cell to reduce the level of noise in the interior cell.

26. The ear seal according to claim 25 wherein the hearing protection device comprises a headset incorporating ANR components.

27. An ear seal for a hearing protection device, comprising:
a cushioned circumaural ear ring that defines an interior cell and an exterior cell and which has an annular base; and
barrier means for effectively extending the annular base into the cushioned ear ring to reduce the level of noise in the interior cell.

28. The ear seal according to claim 27 wherein said barrier means is defined by a material that has a greater density than the density of the cushioned ear ring.

29. The ear seal according to claim 27 wherein the annular base defines a first plane, and the barrier means is defined by a strip that extends in a direction generally transverse to the first plane.

30. The ear seal according to claim 29 wherein the strip is embedded in the ear ring and extends completely around the ear ring.

31. The ear seal according to claim 27 wherein the barrier means is an integral part of the annular base.

32. The ear seal according to claim 31 wherein the barrier means comprises a flange extending around the annular base member and extends into the cushioned ear ring.

33. Apparatus comprising,
an ear cup which defines a substantially fixed volume (SPEC) and a central axis;
an annular cushion for contacting a user's head and encircling the user's ear and the central axis, the cushion having a back surface and a front surface that define respective back and front planes, with the front surface for contacting the user's head, the region between the back and front surfaces having a first density when the cushion is disengaged from a user's ear;
a wall structure that is generally parallel to the central axis and includes a portion extending between the back and front planes generally parallel to the central axis, wherein the wall structure has a density that is greater than the density of the cushion.

34. The apparatus of claim 33 wherein the wall structure comprises a band that encircles the central axis.

35. The apparatus of claim 34 wherein the band has a front edge that is set back from the front plane.
